(19) United States
(12) Patent Application Publication
(10) Pub. No.: US 2022/0229933 A1
(43) Pub. Date: Jul. 21, 2022

(54) SYSTEM FOR SIMPLIFYING AND CONTROLLING DIGITAL PARTICIPATION

(71) Applicant: James Lieb, Albany, NY (US)

(72) Inventor: James Lieb, Albany, NY (US)

(21) Appl. No.: 17/150,115

(22) Filed: Jan. 15, 2021

(51) Int. Cl. G06F 21/62; G06F 21/33

(52) U.S. Cl. CPC G06F 21/6245; G06F 2221/2117; G06F 2221/2141; G06F 21/33

(57) ABSTRACT

A system for simplifying and controlling digital participation is disclosed. The system is configured to simplify digital participation and allow the consumer to control their participation in the digital landscape. The system comprises a publishing tool, an acquisition tool, an administration tool, and an execution tool. The system is configured to perform the simplifying and controlling operation for digital participation. The system simplifies the development process by leveraging a single and extremely secure operation model. The system allows a single model for fine-grained, conditional delegation to all representatives (doctor, lawyer, car company, accounting firm, etc.) and also allows the consumer to track their delegates' usage of their accounts.

### BACKGROUND OF THE INVENTION

The internet has expanded nearly every aspect of our lives, providing easy access to a wide range of information that previously was not readily accessible. In addition, communication possibilities have been vastly increased via the Internet. Thus, great potential exists with regard to simultaneous participation in an organized digital ecosystem. One such environment would include different online marketplaces, where remote users could gather to simultaneously participate in online transactions.

In addition, there should be a way for users or consumers to participate in organized marketplaces where the creation of characters or personas controlled by the user would be useful in furthering entertainment or practical goals in a realistic setting. Examples would include online shopping, online medical and legal services, and accounting firms, etc.

However, the existing systems and methods are limited to local control of digital participation for consumers and users that limit the consumer in controlling their participation in the digital landscape and limiting tracking of their delegates' usage of their accounts.

Henceforth, there is a need for a system for simplifying and controlling digital participation for users and consumers. Further, there is a need for a system to simplify the development process by leveraging a single and highly secure operational model.

### SUMMARY OF THE INVENTION

The present invention discloses a system for simplifying and controlling digital participation for users and consumers and more particularly relates to a system to simplify the development process by leveraging a single, secure operational model based on industry practices and NIST 632. This system lends itself to simplify digital participation and allows the consumer to control their participation in the digital landscape. In one embodiment, the system allows for a single model for fine-grained, conditional delegation to all representatives (doctor, lawyer, car company, accounting firm, etc.). In one embodiment, the system allows the consumer to track their delegates' usage of their accounts.

The system comprises, in one example, a computing device having a memory and a processor, wherein the computing device is in communication with a server via an executed service. In one embodiment, a database in communication with the server is configured to store one or more configurations executable by the processor. The processor executes the one or more configurations to perform an operation, comprising serving, by a consumer credential provider (CCV), metadata and authorization of the personas configured to support specific tool signatures.

In one embodiment, the CCV is configured to perform the following operations, including, but not limited to, supporting, by a repository authentication section, consumer authentication based on administrative authority, controlling, by a repository authorization section, provider resources and credential metadata, wherein the credential metadata is controlled by registering and validating providers configured to support the delegation information for the acquired resources including appropriate persona, controlling, by a repository authorizations section, provider resources and credential metadata given to consumers by an administrator configured to support sub-delegation information for acquired resources. This includes appropriate persona; controlling, by a repository delegated authorizations section, provider resources and credential metadata given to consumers by an administrator, wherein the delegated authorizations are authorizations given to the persona by another persona; supporting, by a repository persona management section, a single sign-on concept where an individual persona links other persona under a single management persona.

In one embodiment, the operation further comprises verifying, by a user interface (UI), metadata for consumers by integrating with the CCV and a controller; accepting, by an adapter, controller credentials based on a registered context object, wherein the adapter is coupled with the controller, and coordinating, by the controller, all event triggering of tools and configured through registration and acquisition.

In one embodiment, the CCV comprises two components including an identity provider (IdP) and a persona credential metadata repository. In one embodiment, the CCV further comprises one or more features including a persona identity, a persona authorization, a delegated authorization, and a persona management. In one embodiment, the persona identity comprises the metadata and the identity or the persona configured to serve IdP functionality. In one embodiment, the persona authorization comprises the metadata to support specific tool signatures.

In one embodiment, the delegated authorization comprises the metadata to support specific tool signatures and capabilities allowing other personas resources. In one embodiment, the persona management allows single sign on across personas. In one embodiment, the persona management allows only personal personas to manage consolidated personas. In one embodiment, the persona management allows an authorized persona to authenticate with their personal account and switch to other registered personas.

In one embodiment, the processor executes the one or more configurations to perform an operation comprising publishing, by a publishing tool, assets with supporting capabilities and policies of usage, registering by an acquisition tool to use the assets, configuring by a consumer administration tool, relationships and tracking assets, configuring by an enterprise administration tool, security relationships and tracking assets, and leveraging by an execution tool, registered data to build the credential for the resource.

In one embodiment, the publication tool is defined with a tool signature having the details including attribute name, domain specific attributes, category of the asset, and classification of the asset. In one embodiment, the acquisition tool is configured to assign a correct persona selected from a list of defined personas for the available CCVvs. In one embodiment, the consumer administration tool determines an authorized asset and the possible persona, and sets one or more parameters of the authorization.

In one embodiment, the enterprise administration tool determines authorized enterprise asset and possible persona, and sets one or more parameters of the authorization. In one embodiment, the execution tool leverages the registered data based on a request received from the consumer.

One aspect of the present disclosure is directed to a system for simplifying and controlling digital participation of a plurality of personas, comprising: (a) a computing device having a memory and a processor, wherein the computing device is in communication with a server via an executed service; (b) a database in communication with the server configured to store one or more configurations executable by the processor, and (c) a controller having a single process pattern, wherein the pattern is embedded on a chip (implemented as software or configurable firmware). In one embodiment, the processor executes the configurations to perform an operation comprising serving, by a consumer credential provider (CCV), metadata and authorization of the personas configured to support specific tool signatures, and wherein the CCV is configured to perform the following operations: supporting, by a repository authentication section, consumer authentication based on verifying authority; controlling, by a repository authorization section, provider resources and credential metadata, wherein the credential metadata is controlled by registering and validating providers configured to support the delegation information for the acquired resources including appropriate persona; controlling, by a repository authorizations section, provider resources and credential metadata given to a consumer by a verifying process configured to support sub-delegation information for acquired resources including appropriate persona; controlling, by a repository delegated authorizations section, provider resources and credential metadata given to a consumer by the verifying process, wherein the delegated authorizations are authorizations given to the persona by another persona; supporting, by a repository persona management section, a single sign-on concept where an individual persona links other persona under a single management persona; (c) verifying, by a user interface (UI), metadata for consumers by integrating with the CCV and a controller; (d) accepting, by an adapter, controller credentials based on a registered context object, wherein the adapter is coupled with the controller; and (e) coordinating, by the controller, all event triggering of tools and configured through registration and acquisition.

In one embodiment, the CCV comprises two components including an identity provider (IdP) and a persona credential metadata repository. In another embodiment, the CCV further comprises one or more features including a persona identity, a persona authorization, a delegated authorization, and a persona management. In one embodiment, the persona identity comprises the metadata and the identity or the persona configured to serve IdP functionality. In another embodiment, the persona authorization comprises the metadata to support specific tool signatures. In one embodiment, the delegated authorization comprises the metadata to support specific tool signatures and capabilities. In another embodiment, the persona management allows single sign on across personas. In one embodiment, the persona management allows only personal personas to manage other personas. In another embodiment, the persona management allows an authorized persona to authenticate with their personal account and switch to other registered personas.

Another aspect of the present disclosure is directed to a system for simplifying and controlling digital participants. The system comprises a computing device having a memory and a processor, wherein the computing device is in communication with a server via an executed service, a database in communication with the server configured to store one or more configurations executable by the processor, wherein the processor executes the one or more configurations to perform an operation comprising: (a) publishing, by a publishing tool, assets with supporting capabilities and policies of usage; (b) registering, by an acquisition tool, to use the assets; (c) configuring, by a consumer administration tool, relationships and track assets; (d) configuring, by an enterprise administration tool, security relationships and track assets; and (e) leveraging, by an execution tool, registered data to build the credential for the resource.

In one embodiment, the publication tool is defined with a tool signature having the details including attribute name, domain specific attributes, category of the asset, and classification of the asset. In another embodiment, the acquisition tool is configured to assign a correct persona selected from a list of defined personas for the asset. In one embodiment, the consumer administration tool determines an authorized asset and the possible persona, and sets one or more parameters of the authorization. In another embodiment, the enterprise administration tool determines authorized enterprise asset and possible persona, and sets one or more parameters of the authorization. In one embodiment, the execution tool leverages the registered data based on a request received from the consumer.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 exemplarily illustrates a block diagram of a system implemented in a computer-implemented environment, according to one embodiment of the present invention;

FIG. 2 exemplarily illustrates a block diagram of a publishing tool of the system, according to one embodiment of the present invention;

FIG. 3 exemplarily illustrates a block diagram of an acquisition registration tool of the system, according to one embodiment of the present invention;

FIG. 4 exemplarily illustrates a block diagram of an administration of the system, according to one embodiment of the present invention;

FIG. 5 exemplarily illustrates a block diagram of an execution process, according to one embodiment of the present invention; and

FIG. 6 exemplarily illustrates a block diagram of a resource in an exemplary embodiment, according to one embodiment of the present invention.

### DETAILED DESCRIPTION

The present invention generally relates to a system for digital participation. More particularly, the present invention relates to a system for simplifying and controlling digital participation and allows consumers to control their participation in the digital landscape. The system also simplifies the development process by leveraging a single and secure operational model based on industry practices.

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

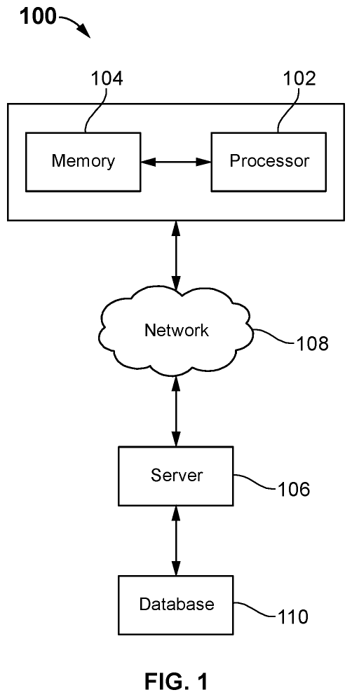

Referring to FIG. 1, a block diagram of a system 100 implemented in a computer-implemented environment for simplifying and controlling digital participation, according to one embodiment of the present invention. In one embodiment, the system 100 is configured to provide a novel and single operational model for all IT emerges. The system 100 simplifies the development process by leveraging a single and extremely secure operation model. In one embodiment, the system 100 lends itself to the simplification of digital participation and allows the consumer to control their participation in the digital landscape. The system 100 allows a single model for fine-grained, conditional delegation to all representatives such as doctor, lawyer, car company, and accounting firm. Further, the system 100 allows the consumer to track their delegates usage of their accounts.

In one embodiment, the system 100 comprises a computing device having a processor 102 and a memory 104 in communication with the processor 102. In one embodiment, the memory 104 includes a software module or a set of instructions executed by the processor 102. In one embodiment, the computing device is in communication with a server 106 via an executed service or a network 108. In one embodiment, the computing device is at least any one of, but not limited to, a smartphone, a mobile phone, a computer, a laptop, a tablet, a personal digital assistant (PDA), or any consumer device including internet of thing (IoT) or connected devices. In one embodiment, this model carries over for delegation of the household devices. The model could be configured in one place, not at every vendor's site. In one embodiment, the network 108 is at least any one of Wi-Fi, Bluetooth®, wireless local area network (WLAN)/Internet connection, and radio communication.

In one embodiment, the system 100 further comprises a database 110. In one embodiment, the database 110 is in communication with the server 106 and is configured to store data related to published policies or configurations. In one embodiment, the database 110 comprises one or more program modules/systems or the one or more configurations, which are executed by the processor 102 to perform multiple operations. In one embodiment, the system 100 further comprises one or more tools/modules configured to perform the simplifying and controlling operation for digital participation. The one or more tools include a publishing tool 200, an acquisition tool 300, an administration tool 400, and an execution tool 500.

In one embodiment, each tool comprises one or more components, including a consumer credential provider (CCV) persona identity, a CCV persona authorization, a CCV delegated authorization, a CCV persona management, an ATLaaS tool adapter, an enterprise tooling, and an ATLaaS controller. In one embodiment, the CCV is a separate entity, which could be delivered independently.

The CCV persona identity contains the metadata and the identity or the persona configured to serve identity provider (IdP) functionality. The CCV persona authorization contains the metadata to support specific tool signatures to get populated as part of the RP (relying party) process aligning with the NIST standard. The CCV delegated authorization contains the metadata to support specific tool signatures and capabilities allowed on other personas resources. The persona management allows for single sign on across personas.

Only the personal personas are allowed to manage other personas. This will allow someone to authenticate with their personal account and switch to other registered personas. The adapter accepts the trusted tool signature and makes the context available for the enterprise tool. The enterprise tooling allows the combination of capabilities tied to the business context supplied by the tool component. The controller is the single point of access for all accesses. It coordinates all event triggering of tools. The controller also supports all RP process and escalation coordination, where part of the registration requires CCVs to be configured.

In one embodiment, these components has two sides including configuration and execution. The CCV is the primary persona identity and authorization metadata. The CCV metadata requires an identifier section, an authorization section, a delegated authorizations section, and a persona management section.

The identifier section comprises one or more general persona identity attributes such as ID, token, persona type, name, email, recovery metadata, and identifier fields by persona type, for example, organization, company. The authorizations section comprises one or more provider metadata such as provider, provider base signature, provider tool delegation signature, provider metadata fields, provider metadata field values, and delegation authority. The authorizations section is a provisioned asset having few patterns. One is the authorizations, which are based on an administrator (enterprise), the others are self-provisioned authorizations.

The self-provisioned authorizations follow an acquisition process that includes all the governance required by the service provider. In one embodiment, different IdPs may be used by an enterprise, where one is for internal/trusted customers and another is for external (self-administered) customers. The authorization section controls the provider resources and credential metadata. In one embodiment, the enterprise is the provider as a bridge to the additional comments. Metadata is controlled by registering and validating providers (RA process or RP process). This section supports the delegation information for acquired resources, including appropriate persona. In one embodiment, the authorization section controls the provider resources and credential metadata given to consumer by an administrator. Additional vetting may be needed on first use. This section supports the sub-delegation information for acquired resources including appropriate persona.

The delegated authorizations section comprises a delegate having an authorizer id and an authorizer token. The authorizer token has provider metadata, which includes provider base signature, provider tool delegation signature, provider metadata fields/role, provider metadata field values, and delegation authority. The delegated authorizations section gives authorizations to the persona by another persona. In one embodiment, the authorization section controls the provider resources and credential metadata given to consumer by an administrator. Delegated authorizations are those authorizations given to the persona by another persona. These have different implementation patterns, including a persona claiming authorizations. The persona management section comprises a person id, a persona token, and a persona type. The persona management section supports a single sign-on concept, where an individual persona could link to other personas under a single management persona.

In one embodiment, each tool further comprises one or more relying parties. It supports authenticated services. The relying parties are integrated with CCV and controller during registration to verify metadata for consumers. In one embodiment, each tool further comprises an ATLaaS compliant XCX (any consumer experience) is based on loosely coupled UI objects/capabilities that are accessed through a published access signature. The asset is always a tool (a combination of capabilities to meet a goal) and the signature is always the superset of exposed metadata. A tool is a “standardized” UI based on common widgets. In one embodiment, the tool is a complex business service.

The widgets include, but not limited to, global header, tool name, context, context interaction, tool UI objects, and UI objects. The global header allows the user to navigate to UI objects that define additional parameters for the tool. For example, the global header is configured to navigate across high level tools; drop down of work/to dos, Home, Preferences, User, etc. The global header accepts parameters from context object such as user id, etc, to drive the presentation.

The tool name is an information based on the tool, where the completion criteria may be an icon. For example, a tabset menu title. The tool name is a part of the credential. The context establishes the high-level context for which the tool works upon. Usually, the customer, patient, etc, but this could be a machine (ITSM like), product, etc. For example, Context area. In a CRM example, the context would be customer and therefore the context header would contain the customer name, address, etc. The context UI object accepts the credential and invokes the context access object to resolve the complete tool context.

The context interaction establishes an integration context. For example, it interacts with workflow, search, and other delivery mechanisms. For example, 2nd level context area supports workflow icons. If a tool signature may be simplified in some instances by exposing only part of a context. An example is with a unit of work (workitem). A work item is always related to a customer, but it is often easier to allow the context object to reconcile the customer. This means the high level of the tool is customer (just like a CRM function, but in this case it may have to do with an order. If a user is only working a certain type of work (say order problem resolution), the tool will specifically designed to help them with that goal. As part of the second level context may be Ui objects (icons) that will allow for seamless integration with dealing with the problem resolution worklist. For example, an icon may allow for the closure of the workitem, or it another UI object may allow for a user to get the next problem (like a call center phone line), etc. This context is not on the high-level context (customer) but on the specific problem (order problem resolution). The context interactions cause actions that interact with the controller. The tool UI objects are configured standard navigation UI objects and serve as integration between context and UI objects. For example, Capability links, Page names, and Customer Header. The tool registration defines the components and integration is handled between the context object and the UI objects. This assures that the UI object signature is satisfied as registered. The UI objects accept parameters and present themselves. For example, customer header. The UI objects are completely independent all signature and actions are registered.

In one embodiment, each tool further comprises an adapter and a controller. The adapter accepts the credential or signature from the controller. It expands the credential based on a registered context object. The adapter may be implemented as part of the complaint XCX or coupled with the controller. The controller is an expansion of Oauth, OpenID, and API gateways. The controller is configured through registration and acquisition. In one embodiment, the controller has a single process pattern, wherein the pattern is embedded on a chip (implemented as software or configurable firmware). In one embodiment, the controller serves as the tool/capability gateway. In one embodiment, the controller is configured to integrate security enforcement relying parties (RP) with credential fulfillment registration.

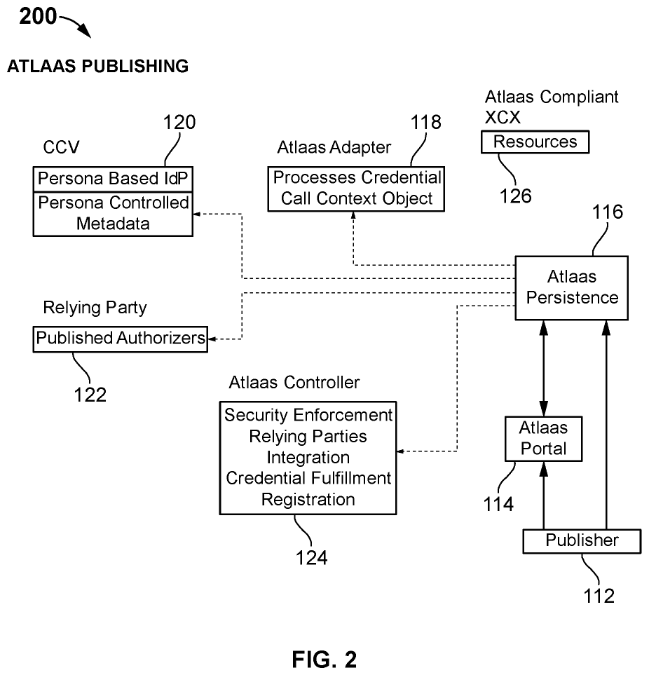

Referring to FIG. 2, a block diagram of a publishing tool 200, according to one embodiment of the present invention. The publishing tool 200 comprises one or more components, including a publisher 112, an ATLaas (Application Tooling Library as a Service) portal 114, an ATLaas persistence 116, an ATLaas adapter 118, a consumer credential provider (CCV) 120, a relying party 122, an ATLaas controller 124, and one or more resources 126. In one embodiment, the publisher 112 is in communication with the portal 114 and the persistence 116. The portal 114 is in communication with the persistence 116. The persistence is in communication with the adapter 118, CCV 120, relying party 122, and the controller 124. In one embodiment, the adapter 118 processes credential call context object. In one embodiment, the CCV 120 is a repository and a producer of credentials for a persona.

The CCV 120 has two components including identity provider (IdP) and a persona credential metadata repository. The IdP is configured to provide persona based IdP. The persona credential metadata repository is configured to provide persona controlled metadata. In one embodiment, the relying parties 122 are published authorizers. The controller 124 is, in one example, configured to integrate security enforcement, relying parties with credential fulfillment registration.

In one embodiment, the publishing tool 200 performs an operation configured to make available of fine-grained resources such as services, tools, and objects. The operation comprises the following steps. At one step, the system directs to publishing tool 200 or a call to service. At another step, the publishing tool 200 is defined as an asset. In one embodiment, the asset is defined with the following details including, but not limited to, name of the tool with full qualification, that is, high level ownership and categorization like HTTP ownership. The asset is then described. Then, an external CCV is assigned for each persona for the asset, wherein the external CCV is a resource used by more than one persona.

In addition, one or more new personas and their vetting process could be defined within this tool or at a later date. In one embodiment, the persona could be a patient, a doctor, a lawyer, or any other external individual. For example, for a doctor persona, a doctor vetting process will be defined. In one embodiment, the vetting process could be a manual process. Further, the context routine, for example patient detail, is defined to reconcile exposed tool signature.

Upon defining the context routine, an acquisition policy is defined, wherein the acquisition policy includes, but is not limited to, a vetting process, approval (no need of approval for self provisioned), testing requirements, ticket open event, etc. The conditions for usage are then defined, which are complex event-based triggers. For example, a car company can access the vehicle services only if there is an accident or if the vehicle is stolen. Further, the tool signature is defined with multiple attributes. The tool signature includes all the metadata needed for the tool to work properly. In one embodiment, each attribute has details including, but not limited to, attribute name, RP for all domain specific attributes, categorization of the asset, and classification of the asset.

The RP process includes either an API or UI location and they need to be qualified appropriately, if only an API ATLaas security implements the UI. Optionally, categorization of the asset may involve creating a bundle of products, for example bundled applications for usage by persona, individual bundle, or business bundle. In one embodiment, the products are assets. Optionally, the classification of assets could be used to establish governance of assets, where some assets require a higher level of authentication. In addition, some assets may be accessible only in certain locations or validated at a higher trust level. For example, if the trust level is above zero, other types of multi-factor authentication would be required. The additional levels of authentication may include, but not be limited to, biometric, text, out of band, etc., in stream enhanced verification.

At another step, the asset is published. At another step, a request made to access the resource gets processed. To process the request, the parameters are validated. The tool then analyses whether the owner/publisher is valid and authorized for the CCV (CA function). The resources are then stored in the resource signature in the persistence (controller repository) with the acquisition policy. The CCV authorities for metadata is established. The CCV metadata will include the RP service implementation by attributes. At another step, the resource is made available on the asset acquisition screen.

In one embodiment, the publishing pattern used for external customers comprises the following steps. At one step, the provider uses the publisher tool. At another step, the tool/asset is defined with one or more details. For example, https:CompanyABC,com/resolvepatientiss/<PatientNum> <IssueType> (exposed signature). Then the asset is described with description, use, etc. An external CCV is assigned, which could be used as a resource by more than one persona. The context routine, for example, patient detail, is then defined. Upon context routine, acquisition policy is defined, which could be tied to a patient issue ticket open event occurring.

The patient detail, for example, <PatientNum>, CCV=CompnayABC/PatientNum, RP=http/ComanyABC.com/verifypatient, is then added to the patient bundle, wherein the new patient detail could be defined in line. If the trust level0, other required multi-factor authentication is established. At another step, the asset is published. At another step, the authentication is validated and the metadata is stored appropriately. At another step, the resource, for example, Resource https:CompanyABC.com/resolvepatientiss/<PatientNum> <IssueType> (exposed signature) is made available.

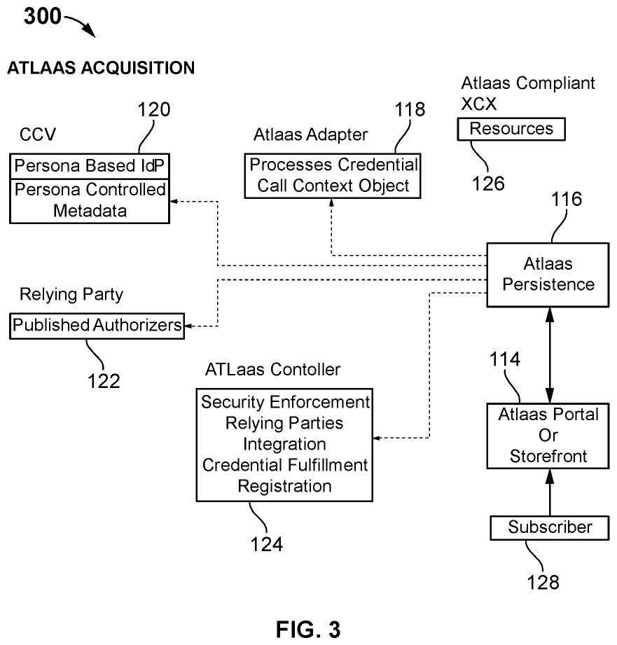

Referring to FIG. 3, a block diagram of an acquisition tool 300, according to one embodiment of the present invention. The acquisition tool 300 comprises one or more components, including a subscriber 128, an ATLaas (Application Tooling Library as a Service) portal or storefront 114, an ATLaas persistence 116, an ATLaas adapter 118, a consumer credential provider (CCV) 120, a relying party 122, an ATLaas controller 124, and one or more ATlaaS compliant XCX or resources 126. In one embodiment, the subscriber 112 is in communication with the portal 114. The portal 114 is in communication with the persistence 116.

The persistence is in communication with the adapter 118, CCV 120, relying party 122, and the controller 124. In one embodiment, the adapter 118 processes credential call context object. In one embodiment, the CCV 120 is a repository and a producer of credentials for a persona. The CCV 120 has two components, including identity provider (IdP) and a persona credential metadata repository. The IdP is configured to provide persona based IdP. The persona credential metadata repository is configured to provide persona controlled metadata. In one embodiment, the relying parties 122 are published authorizers. In one embodiment, the controller 124 is configured to integrate security enforcement relying parties with credential fulfillment registration.

In one embodiment, the acquisition tool or storefront 300 performs an operation configured to make available fine-grained resources such as services, tools, and objects. The operation comprises the following steps. At one step, the system directs to acquisition tool 300 having a list of available tools or an integrated tool similar to an app store. A persona filter could be used to select an appropriate tool catalog. At another step, appropriate assets or categorized group of assets for which an access is required, is determined. At another step, the usage policy is investigated. It may be immediate or require approval or additional vetting.

At another step, one or more personas for assignment are determined from a list of defined personas listed in a pane. The list may be categorized by persona type such as external personas, enterprise employees, etc. In one embodiment, a new persona type could be added, where the persona type needs a defined vetting process. In one embodiment, a role categorization could be defined for certain personas. For example, a role of “call center rep” may be a role for enterprise users, wherein the role is given to the employee and maintained in the CCV. A correct persona (role) for the asset is selected from the list.

At another step, the policy of usage and metadata that will be used are established. In one embodiment, certain agreements may be a part of this purchase. The subscriber may be requested to share data of the CCV. The signature is very specific over what needs to be shared. The purchase is where the agreement of sharing between consumer and provider is established. At another step, delegation policy is established. For example, when an consumer gets access to their health record, they can delegate to their doctor. This can be done as bundles. At another step, business policy is established.

Along with other assets, there may be reason to get access to very high value assets. These may be very fine-grained, and policy based. For example, law enforcement may require access to a certain personas asset, which could be done through a business policy. These policies can have a time limitation and immediate notification of use. In this case, a defined law enforcement persona could request the asset and the policy (approvals, etc.). At another step, a policy is created and published to the controller. It may establish some attribute containers in the CCV (e.g., establish the ability for an RA to write to the CCV). The policy is established for security.

In one embodiment, the acquisition pattern used for external customers, for example, subscribers, comprises the following steps. At one step, the customer uses the ATLaaS subscription portal or app store. At another step, he/she determines the correct asset from the list of defined assets. For example, https:CompanyABC.com/resolvepatientiss/<PatientNum><IssueType> (exposed signature). At another step, a correct persona, for example, an individual, is selected from a list of available personas for that consumer. In case of enterprise, a role for the persona is also selected. At another step, authentication of the parameters and customization occurs. At another step, authentication to delegate policy, for example, cross account delegation to a health proxy or doctor. At another step, the subscription process is completed.

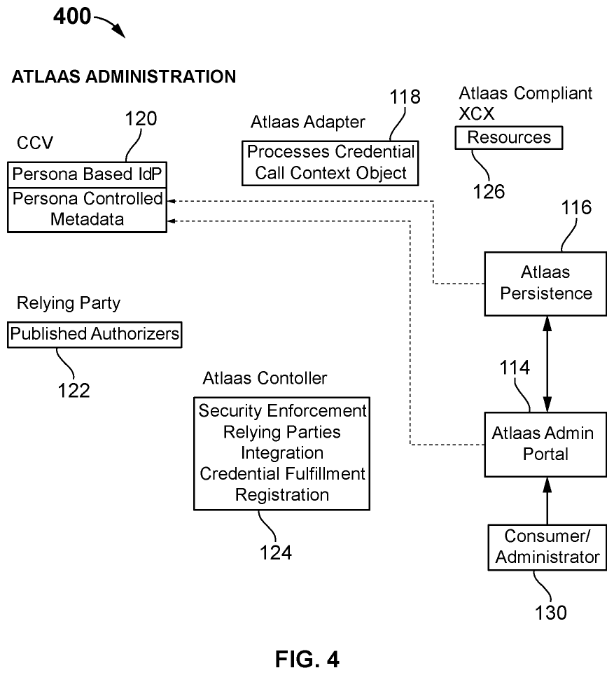

Referring to FIG. 4, a block diagram 400 of an administration of the system 100 in one embodiment is disclosed. In one embodiment, the administration of the system 100 includes the ATLaaS admin portal 114, ATLaas persistence 116, ATLaaS adapter 118, consumer credential provider (CCV) 120, and relying party (published authorizers) 122, ATLaaS controller 124, and resources (ATLaaS complaint XCX) 126. In one embodiment, the consumer/administrator 130 could configure relationships and track assets. From a consumer perspective, registered delegated partners, for example, doctors, lawyers, car companies, etc. could be configured. In one embodiment, a system administration could configure security relationships and track assets. This includes delegating to partners. This model could also support distributed administration.

In one embodiment, the process for selecting a persona or a company by the consumer/administrator 130 includes different steps. At one step, the consumer/administrator 130 could check the system or CCV store front and check the authorized asset to which access is to be granted. At another step, the consumer/administrator 130 chooses a possible persona to be delivered and each asset will have a defined list. At another step, the consumer/administrator 130 could search for choosing the right individual persona or company and also be able to assign to a law or an accounting firm.

At another step, the consumer/administrator 130 could set parameters of the authorization. There may be certain agreements tied to the access. For example, a car company may access these assets only if there is a car accident. At another step, the consumer/administrator 130 could establish the sub-delegation (optional). In one embodiment, the sub-delegation includes multiple queries. For example, can this asset be delegated to another persona, what persona attributes are required for the delegation, can the resource be further delegated (e.g., can a doctor give access to another doctor and by what policy (approval)). This may seem difficult, but what it means is when an employee gets access to their health record, they could delegate to their doctor. This could be done as bundles. The system could create the policy and publish to the ATLaaS repository. Populate values in the CCV (establish the ability for an RA to write to the CCV).

In one embodiment, the process for selecting a persona and metadata (role) by the enterprise administration includes different steps. In one embodiment, the system administration could configure security relationships and track assets. This includes delegating to partners. This model supports distributed administration. At one step, the ATLaaS or CCV store front or common security administration panel could be checked. At another step, the system administration could find the authorized enterprise asset to which access is to be granted. At another step, the system administration could choose a possible persona and metadata (role), the asset to be offered, and also perform search to find the right individual persona or organization or role. At another step, the parameters could be set for the authorization. There may be certain agreements tied to the access. An employee may get access, if there is a help ticket.

At another step, the consumer could establish the sub-delegation (this is optional). In another embodiment, the system administration can establish the sub-delegation. In one embodiment, the system administration includes enterprise and system admins. In one embodiment, the sub-delegation includes multiple queries, for example, can this asset be delegated to another persona, what persona attributes are required for delegation, can the resource be further delegated (can a doctor give access to another doctor and by what policy (approval)). This may seem difficult, but what it means is when an employee gets access to their health record, they could delegate to their doctor. This could be done as bundles. The system could create the policy and publish to the ATLaaS repository. Populate values in the CCV (establish the ability for an RA to write to the CCV).

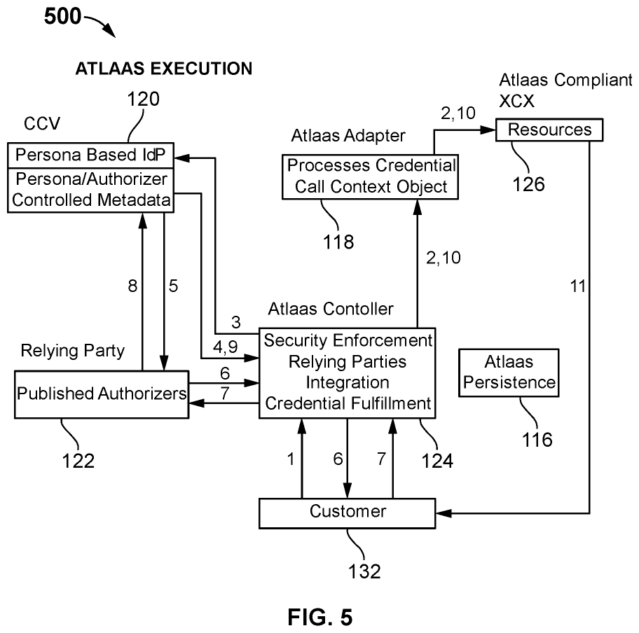

Referring to FIG. 5, a block diagram 500 of an execution process in one embodiment is disclosed. In one embodiment, the registered data is leveraged to build the credential for the resource. At one step, the consumer 132 makes a request for fine-grained resource. The request could be received and evaluated by the system controller and/or a processor (security enforcement relying parties and integration credential fulfilment) 124. If all the parameters are satisfied, the credential is passed to the resources 126 via the system adapter 118 through the path 2. If the credential parameters are required to be satisfied, then path 3 could be executed. At another step, the system adapter 118 accepts credentials and reconciles the metadata. The defined context object/routine is called by the system adapter 118 and the parameters are used to deliver capabilities by the resources (ATLaaS compliant XCX) 126.

At another step, if an authentication is required then the current request could be suspended and then path 5 could be executed by the CCV 120 using an appropriate and defined authentication method. Once successfully authenticated, then the CCV 120 could trigger the suspended transaction. If the CCV 120 has the parameters, then the credential could be populated and then path 4 could be executed. If some parameters require to vet or examine, then the original request could be suspended and then path 5 is executed using the registered published authorizer. This step repeats until all the parameters are satisfied and then the credential is populated and path 9 could be executed. In one embodiment, the CCV 120 comprises persona-based Identity Provider (IdP) and persona/authorizer-controlled metadata.

At another step, the system controller (ATLaaS controller) 124 receives the populated credential and executes step 2. In one embodiment, the system controller 124 comprises security enforcement relying parties and integration credential fulfilment. At another step, the relying party 122 could invoke the registered vetting module. At another step, the request is sent back to the consumer 132 for additional input. At another step, the response could be validated by the relying party (published authorizer) 122. This process is invoked until success. The new parameters could be passed back through path 8 to the CCV 120.

At another step, the parameters or authentication is passed by the CCV 120. The parameters are stored in the CCV 120. The authentication information and parameters are added to the credential. At another step, the populated credential is received from the system controller 124 (ATLaaS controller). At another step, the credential is accepted and metadata is reconciled by the ATLaaS adapter 118. The defined content object/routine is called by the ATLaaS adapter 118 and the parameters are used to deliver capabilities/tools to the resources (ATLaaS compliant XCX) 126. Further, at another step, the requested capabilities/tools are returned to the customer 132 after successful completion of the execution process.

In one embodiment, there is only one model for execution. In another embodiment, there may be more than one CCV in use by an enterprise to support different personas. An enterprise may leverage different CCVs for employees, external customers or partners. The registration of the tool/capability is used to define a persona. When the same tool is leveraged across personas, two implementation options could be used for the right persona context. In one embodiment, the tool could be addressed differently on registration. Experience implies that creating another tool which is more flexible simplifies future customization by persona.

In one embodiment, the registration of the tool defines all the execution metadata. The deliverer states the tool address, tool signature, CCVs, and the personas. RPs are registered the same way. For parameters in the signature, it defines the relying party asset that must be used.

In one embodiment, the authentication services are leveraged by the CCV include “step up” authentications that could be enforced based on the resource accessed. In the execution model, authentication is collapsed into the execution model because it requires consumer intervention similar to relying party vetting. It is a best practice to store the parameters in the CCV 120 as derived tokens, rather than clear text parameters. The only consumer of those parameters is the ATLaaS tool's credential consumer and the relying party objects. All that is needed is the handshake between the two. In one embodiment, the credential consumer could then unpack them for tool usage. In one embodiment, different ATLaaS implementations should support credential caching at the controller level.

In one embodiment, all credentials should support a single enforcement policy on termination that could be determined by a combination of persona, resource, and usage pattern. From a networking perspective, the only thing connected to the credentialing services of the CCV is the ATLaaS controller 124. The only place a tool could be called from is the ATLaaS controller 124. Therefore, a robust ATLaaS controller infrastructure is required.

In one embodiment, the ATLaaS controller 124 serves as the tool/capability gateway. This unique position allows for many additional benefits. The most significant is a user log of accesses and parameters. It could determine the contextual click stream of the user. This pattern logs all accesses so that a log of users who accessed a certain account (any metadata), when and in what context (Tool) is available. In the future, when there may be generally available ATLaaS implementations (ATLaaS as a service), a personal firewall may be established so that the consumer could see all the accesses from their delegated parties.

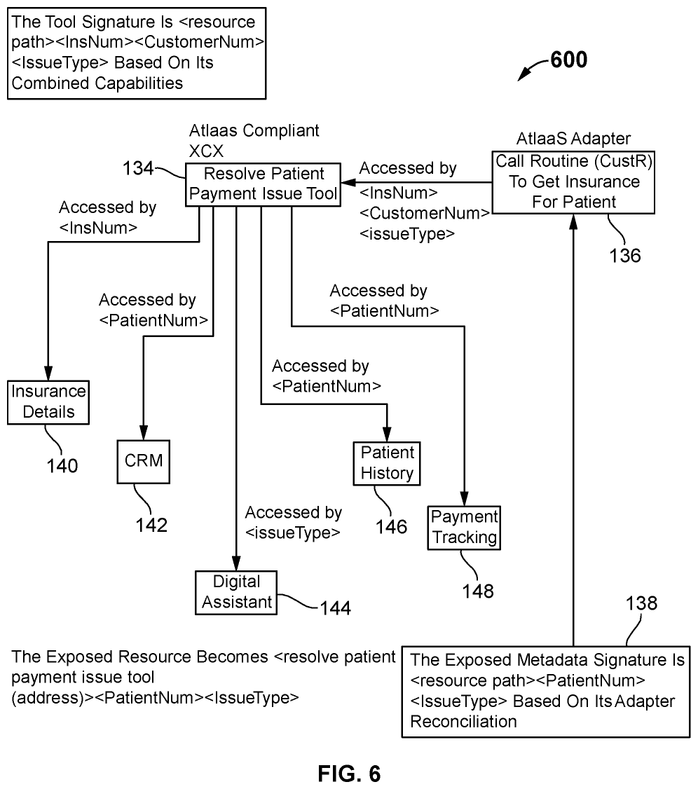

Referring to FIG. 6, a block diagram 600 of a resource in an exemplary embodiment is disclosed. In one embodiment, the credential is comprised of at least 3 sections, including authorization details, a resource, and resource details. In one embodiment, the authorization details include, but are not limited to, owner of the credential, user, user name, persona, trust level, and authentication. In one embodiment, the high-level resource is accessed. It is the resource that some security frameworks use today (for example, like a web page). In one embodiment, the metadata sets the context for the resource. It is not customer account detail, it is specifically customer John Smith's account details.

For example, the resource could become a resolve patient payment issue tool 134. The resolve patient payment issue tool 134 is connected to the insurance details 140, CRM 142, digital assistant 144, patient history 146, payment tracking 148, and the ATLaaS adapter 136. In one embodiment, the tool signature could be a resource path, an insurance number, a customer number, and an issue type based on its combined capabilities. In one embodiment, the ATLaaS adapter 136 calls routine (CustR) to get insurance for the patient. The ATLaaS adapter 136 could receive patient information from the metadata. In one embodiment, the exposed metadata signature could be a resource path, patient number, and issue type, based on its adapter reconciliation. In one embodiment, the exposed resource becomes a resolve patient payment issue tool.

In an exemplary embodiment, the process for consumer delegation includes different steps. At one step, the consumer accesses the admin panel and finds the asset resolve patient payment issue tool, which has context of the patient. At another step, the consumer finds a persona for delegation and selects a persona from the registered drop down options for a resource and may select doctors for example. At another step, the consumer finds the desired doctor or a firm by searching. At another step, the consumer sets the condition and the doctor can access this if an issue is reported. The doctor could not delegate, but a practice may. Further, at another step, the authorization is finalized.

In an exemplary embodiment, the process for enterprise delegation includes different steps. At one step, the administrator accesses the admin panel and finds the asset resolve patient payment issue tool with a context. At another step, the administrator finds a persona for delegation and selects a persona from the registered drop down for the resource. At another step, the administrator selects issue resolvers. At another step, the administrator sets condition and the resolvers could gain access only if an issue is reported. The business rules could be determined if delegation is available. One possible pattern is to transfer to the issue resolver and managers and let them delegate. Further, at another step, the authorization is finalized.

One aspect of the present disclosure is directed to a system for simplifying and controlling digital participation of a plurality of personas. The system comprises (a) a computing device having a memory and a processor, wherein the computing device is in communication with a server via an executed service; (b) a database in communication with the server configured to store one or more configurations executable by the processor, wherein the processor executes the configurations to perform an operation comprising: (i) serving, by a consumer credential provider (CCV), metadata and authorization of the personas configured to support specific tool signatures, wherein the CCV is configured to perform the following operations: supporting, by a repository authentication section, consumer authentication based on administrative authority; controlling, by a repository authorization section, provider resources and credential metadata, wherein the credential metadata is controlled by registering and validating providers configured to support the delegation information for the acquired resources including appropriate persona; controlling, by a repository authorizations section, provider resources and credential metadata given to a consumer by an administrator configured to support sub-delegation information for acquired resources including appropriate persona; controlling, by a repository delegated authorizations section, provider resources and credential metadata given to a consumer by an administrator, wherein the delegated authorizations are authorizations given to the persona by another persona; and supporting, by a repository persona management section, a single sign-on concept where an individual persona links other persona under a single management persona; and (c) verifying, by a user interface (UI), metadata for consumers by integrating with the CCV and a controller; (d) accepting, by an adapter, controller credentials based on a registered context object, wherein the adapter is coupled with the controller, and (e) coordinating, by the controller, all event triggering of tools and configured through registration and acquisition.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A system for simplifying and controlling digital participation of a plurality of personas, comprising:
(a) a computing device having a memory and a processor, wherein the computing device is in communication with a server via an executed service;
(b) a database in communication with the server configured to store one or more configurations executable by the processor, wherein the processor executes the configurations to perform an operation comprising:
serving, by a consumer credential provider (CCV), metadata and authorization of the personas configured to support specific tool signatures, wherein the CCV is configured to perform the following operations:
supporting, by a repository authentication section, consumer authentication based on administrative authority;
controlling, by a repository authorization section, provider resources and credential metadata, wherein the credential metadata is controlled by registering and validating providers configured to support the delegation information for the acquired resources including appropriate persona;
controlling, by a repository authorizations section, provider resources and credential metadata given to a consumer by an administrator configured to support sub-delegation information for acquired resources including appropriate persona;
controlling, by a repository delegated authorizations section, provider resources and credential metadata given to a consumer by an administrator, wherein the delegated authorizations are authorizations given to the persona by another persona;
supporting, by a repository persona management section, a single sign-on concept where an individual persona links other persona under a single management persona;
(c) verifying, by a user interface (UI), metadata for consumers by integrating with the CCV and a controller;
(d) accepting, by an adapter, controller credentials based on a registered context object, wherein the adapter is coupled with the controller, and
(e) coordinating, by the controller, all event triggering of tools and configured through registration and acquisition.

2. The system of claim 1, wherein the CCV comprises two components including an identity provider (IdP) and a persona credential metadata repository.

3. The system of claim 1, wherein the CCV further comprises one or more features including a persona identity, a persona authorization, a delegated authorization, and a persona management.

4. The system of claim 3, wherein the persona identity comprises the metadata and the identity or the persona configured to serve IdP functionality.

5. The system of claim 3, wherein the persona authorization comprises the metadata to support specific tool signatures.

6. The system of claim 3, wherein the delegated authorization comprises the metadata to support specific tool signatures and capabilities on other personas resources.

7. The system of claim 3, wherein the persona management allows single sign on across personas.

8. The system of claim 3, wherein the persona management allows only personal personas to manage other personas.

9. The system of claim 3, wherein the persona management allows an authorized persona to authenticate with their personal account and switch to other registered personas.

10. A system for simplifying and controlling digital participants, comprising a computing device having a memory and a processor, wherein the computing device is in communication with a server via an executed service, a database in communication with the server configured to store one or more configurations executable by the processor,
wherein the processor executes the one or more configurations to perform an operation comprising:
publishing, by a publishing tool, assets with supporting capabilities and policies of usage;
registering, by an acquisition tool, to use the assets;
configuring, by a consumer administration tool, relationships and track assets;
configuring, by an enterprise administration tool, security relationships and track assets, and
leveraging, by an execution tool, registered data to build the credential for the resource.

11. The system of claim 10, wherein the publication tool is defined with a tool signature having the details including attribute name, domain specific attributes, category of the asset, and classification of the asset.

12. The system of claim 10, wherein the acquisition tool is configured to assign a correct persona selected from a list of defined personas for the asset.

13. The system of claim 10, wherein the consumer administration tool determines an authorized asset and the possible persona, and sets one or more parameters of the authorization.

14. The system of claim 10, wherein the enterprise administration tool determines authorized enterprise asset and possible persona, and sets one or more parameters of the authorization.

15. The system of claim 10, wherein the execution tool leverages the registered data based on a request received from the consumer.
